(19) United States
(12) Patent Application Publication
(10) Pub. No.: US 2008/0259203 A1
(43) Pub. Date: Oct. 23, 2008

(54) Systems And Methods For Identifying Camera Sensors

(76) Inventors: Andrew C. Goris, Loveland, CO (US); Kevin M. Brokish, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/738,067

(22) Filed: Apr. 20, 2007

(51) Int. Cl. H04N 5/235

(52) U.S. Cl. 348/362; 348/E05.034

(57) ABSTRACT

Systems and methods for identifying camera sensors are disclosed. In an exemplary implementation, a method for identifying camera sensors may include exposing a plurality of camera sensors at a time T1, each of the plurality of camera sensors having an array of pixels, and storing the location of unique pixels within the array of pixels for each of the camera sensors exposed at time T1 in a data structure. The method may also include exposing one of the plurality of camera sensors at time T2, and comparing the unique pixels within the array of pixels for the one camera sensor exposed at time T2 with locations of unique pixels of each of the camera sensors exposed at time T1. The one camera sensor may be identified based on the comparing step.

### BACKGROUND

Conventional film and more recently, digital cameras, are widely commercially available, ranging both in price and in operation from sophisticated single lens reflex (SLR) cameras used by professional photographers to inexpensive “point-and-shoot” cameras that nearly anyone can use with relative ease.

Digital cameras include at least one camera sensor, such as, e.g., a charge coupled device or “CCD” or complementary metal oxide semiconductor (CMOS) sensor. The digital camera includes a plurality of photosensitive cells, each of which builds-up or accumulates an electrical charge in response to exposure to light. The accumulated electrical charge for any given pixel is proportional to the intensity and duration of the light exposure, and is used to generate digital photographs

These camera sensors are typically mass-produced and often times do not have any form of identifier to distinguish one sensor from another. However, it is often necessary to know which sensor is used in which camera in order to properly calibrate the sensor. Although identifiers can be added to the sensors during the manufacturing process, this adds to the manufacturing time, complexity and cost.

### BRIEF DESCRIPTION OF THE DRAWINGS

FIG. 1 is a component diagram of an exemplary camera system

FIG. 2 is a high-level diagram of an exemplary camera sensor.

FIGS. 3a-b are high-level diagrams of an exemplary camera sensor illustrating (a) pixel data after exposure of the camera sensor at time T1, and (b) pixel data after exposure of the camera sensor at time T2.

FIG. 4 is a flowchart illustrating exemplary operations which may be implemented for identifying camera sensors.

### DETAILED DESCRIPTION

Systems and methods are disclosed herein for identifying camera sensors. In an exemplary embodiment, each of a plurality of camera sensors (e.g., CCD or CMOS sensors) is exposed to a fixed scene (e.g., a dark field or a white field) at least a first time. The pixel data from each exposure is analyzed to identify unique pixels and stored in a data structure. The location of unique pixels on each camera sensor is specific to the camera sensor and serves as a “signature”. Accordingly, when a camera sensor needs to be identified at a later time, the camera sensor is again exposed to substantially the same fixed scene, and the pixel data compared to pixel data stored in the data structure to identify matching (or substantially matching) unique pixels. The sensor's signature may then be used to identify the camera sensor, as explained in more detail below with reference to the figures. The techniques described herein are easy to implement, fast, and fault-tolerant.

Before continuing, it is noted that term “unique” as used herein with regard to pixels is defined as pixels having charges which deviate significantly from the typical charge read from the other pixels under fixed conditions. For example, so-called “hot” pixels are pixels which exhibit a greater charge when read out from the sensor after photographing a white field, and may be used as “unique” pixels according to the teachings herein. Likewise, so-called “cold” pixels are pixels which exhibit a lesser charge when read out from the sensor after photographing a dark field, and may also be used as “unique” pixels according to the teachings herein.

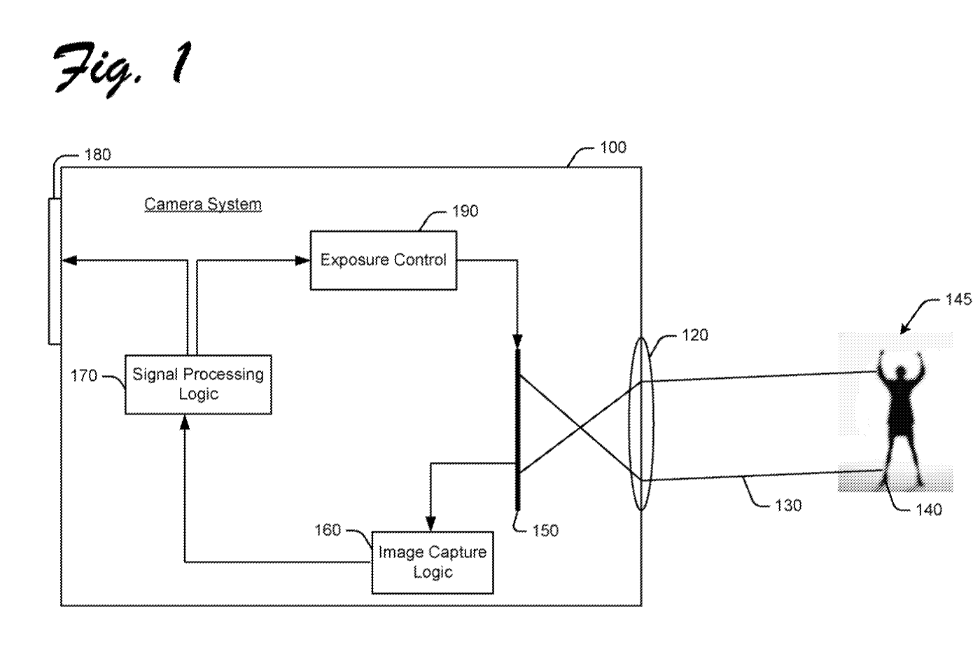

FIG. 1 is a component diagram of an exemplary camera system 100. Although reference is made to a particular digital still-photo camera system 100, it is noted that the systems and methods described herein for identifying camera sensors may be implemented with any of a wide range of digital still-photo and/or video cameras, now known or that may be later developed. The systems and methods may also be used for other imaging devices that incorporate CCDs or CMOS sensors (e.g., medical imaging devices and one-dimensional sensor arrays commonly used in computer scanners).

Exemplary camera system 100 may include a lens 120 positioned in the camera system 100 to focus Sight 130 reflected from one or more objects 140 in a scene 145 onto a camera sensor 150. Exemplary lens 120 may be any suitable lens which focuses light 130 reflected from the scene 145 onto camera sensor 150.

Camera system 100 may also include image capture logic 160. In digital cameras, the image capture logic 160 reads out the charge build-up from the camera sensor 150. The image capture logic 160 generates image data signals representative of the light 130 captured during exposure to the scene 145. The image data signals may be implemented by the camera for auto-focusing, auto-exposure, pre-flash calculations, image stabilizing, and/or detecting white balance, to name only a few examples.

The camera system 100 may be provided with signal processing logic 170 operatively associated with the image capture logic 160. The signal processing logic 170 may receive as input image data signals from the image capture logic 160. Signal processing logic 170 may be implemented to perform various calculations or processes on the image data signals, e.g., for output on the display 180.

In addition, the signal processing logic 170 may also generate output for other devices and/or logic in the camera, system 100. For example, the signal processing logic 170 may generate control signals for output to exposure control module 190 to adjust exposure time of the camera sensor 150 (e.g., decreasing exposure time for a brightly lit scene or increasing exposure time for a dimly lit scene.

In any event, the camera sensor 150 may need to be calibrated for use in the particular camera system 100. Manufacturing or other data that characterizes the camera (e.g., spectral response, light sensitivity, and color vignetting, etc.) for the individual camera sensor (i.e., the sensor by itself or sensor/lens combination) may be needed in order to properly calibrate the camera sensor 150. Accordingly, it may be necessary to identify the camera sensor 150 before or even after it has been installed in the camera system 100. This allows calibration information, characterization, or other sensor-specific information that is known (e.g., lot number) or measured (e.g., calibrations) at the time and location of sensor manufacture to be used later or stored at the time the sensor is incorporated into the camera. The ID information may also be stored in the camera and the calibration data created at manufacture time could then be recalled (e.g. from a server) at a later time, e.g., to be used with the device.

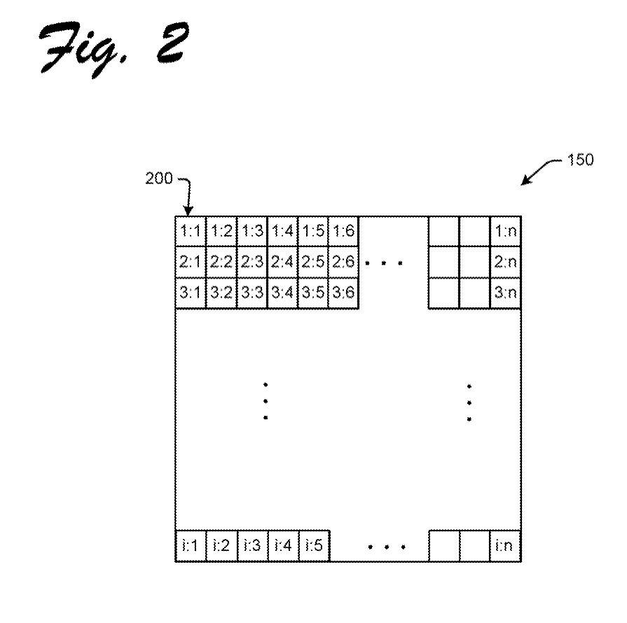

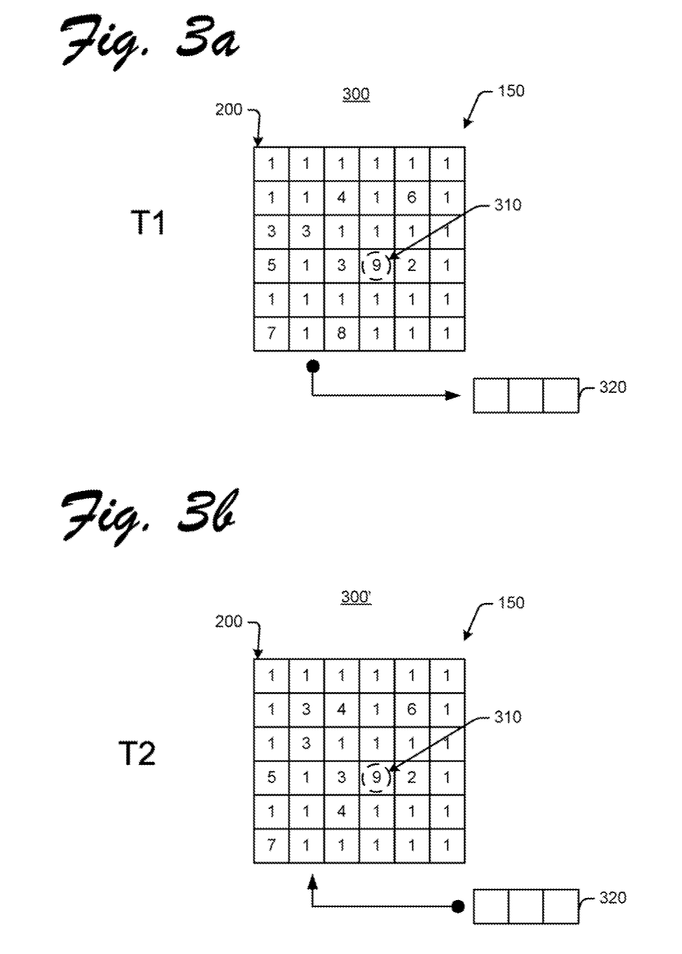

Exemplary embodiments for identifying the camera sensor 150 can be better understood with reference to the exemplary camera sensor shown in FIG. 2 and illustrations shown in FIGS. 3a-b.

FIG. 2 is a high-level diagram of an exemplary camera sensor 150, such as the camera sensor described above for camera system 100 shown in FIG. 1. For purposes of this illustration, the camera sensor 150 is implemented as an interline CCD. However, the camera sensor 150 is not limited to interline CCDs. For example, the camera sensor 150 may be implemented as a frame transfer CCD, an interlaced CCD, CMOS sensor, or any of a wide range of other camera sensors now known or later developed.

In an interline CCD, every other column of a silicon sensor substrate is masked to form active photocells (or pixels) 200 and inactive areas adjacent each of the active photocells 200 for use as shift registers (not shown). In FIG. 2, the photocells 200 are identified according to row:column number. For example, 1:1, 1:2, 1.3, . . . 1:n correspond to columns 1-n in row 1; and 2:1, 2:1, 2:2, 2:3, . . . 1:n correspond to columns 2-n in row 2.

Although n columns and i rows of photocells, it is noted that the camera sensor 150 may include any number of photocells 200 (and corresponding shift registers). The number of photocells 200 (and shift registers) may depend on a number of considerations, such as, e.g., image size, image quality, operating speed, cost, etc.

During operation, the active photocells 200 become charged during exposure to light reflected from the scene. This charge accumulation (or “pixel data”) is then transferred to the shift registers after the desired exposure time, and may be read out from the shift registers. The pixel data may be used to locate unique pixels and thereby identity the camera sensor, as explained in more detail with reference to FIGS. 3a-b.

FIGS. 3a-b are high-level diagrams of an exemplary camera sensor 150 illustrating (a) pixel data 300 for each pixel 200 after exposure of the camera sensor 150 at time T1, and (b) pixel data 300′ for each pixel 200 after exposure of the camera sensor 150 at time T2. For purposes of simplification, the camera sensor 150 is shown having six columns and six rows of active photocells 200. The charge accumulation or pixel data 300 and 300′ is shown as numerical values ranging from the value “1” (indicating a low level light) to the value “9” (indicating a very bright light), although in most sensors having 10-bit intensity values, the range is actually from about 0 to 1023.

In this example, the camera sensor 150 is exposed to the dark field at time T1 (e.g., during manufacture). Accordingly, the pixel data 300 includes mostly “1s” (indicating the generally low light level), with several unique photocells having higher pixel values (e.g., pixel value “9” in photocell 310 in FIG. 3a). After the desired exposure time, the pixel data 300 may be transferred from the active photocells 200 to the shift registers (not shown), read out, and stored in a data structure 320 (e.g., in computer readable storage or memory).

In an exemplary embodiment, the data structure may include fields for storing the pixel location (e.g., 1:1. 1:2, etc.), and a specific identifier (e.g., serial number) corresponding to each camera sensor 150 having a unique pixel at that pixel location. The data structure also may allow multiple camera IDs to be stored under each possible pixel location. For example, the data structure may be thought of as having three million “drawers,” each representing a pixel location on a three mega-pixel camera sensor 150. Each “drawer” contains a few cameras that have unique pixels at that location. An exemplary data structure is shown in Table 1.

TABLE 1
Exemplary Data Structure

| Pixel Number | Camera Sensor Identifiers |
|---|---|
| 1:1 | 0134; 298; 433; . . . |
| 1:2 | 0134 |
| . . . | |
| 1:n | 298; 433; . . . |
| 2:1 | 109; 328; . . . |
| 2:2 | 0134; 328; . . . |
| . . . | |

The location of unique pixels on each camera sensor 150 is specific to each camera sensor and serves as a “signature”. Accordingly, the pixel data stored in the data structure may be used to identify the camera sensor at a later time.

At some later time T2 (e.g., when the camera sensor 150 needs to be identified), the camera sensor 150 is again exposed to the same (or substantially the same) scene (e.g., a dark field), and for the same (or substantially the same) time (e.g., T1=T2). If it is not possible to expose the camera sensor 150 to the same scene, or for the same time, image recognition, vector tracking, and time division techniques may be used to compensate for any differences in exposure time and/or scene. Such techniques are well-understood in the photography arts, and therefore a full explanation is not needed here.

After the desired exposure time, the pixel data 300′ may be transferred from the active photocells 200 to the shift registers (not shown), read out, and compared to pixel data in the data structure 320. In an exemplary embodiment, the comparison may be handled by a comparison engine. The comparison engine may be implemented as logic residing in memory and executing on a processor in the camera system or as a separate device (e.g., a computer system used for calibrating the camera system).

If the pixels identified as unique pixels match (or substantially match) the unique pixels stored in the data structure 320, the corresponding camera sensor identifier stored in the data structure 320 may be used to identify the camera sensor 150.

In an exemplary embodiment, the comparison engine does not need to access separate data structures for all of the sensors ever recorded (this would take a long time). Instead, the comparison only compares the unique pixels identified at time T2, and determines the most common sensor in the “drawers” of the data structure corresponding to unique pixels. In one example, the comparison engine takes a predetermined number of unique pixels from time T2 and compares those unique pixels to the corresponding “drawers.” The most common sensor identity in those “drawers” is the identity of the camera sensor.

It is noted that some of the unique pixels may change over time due to any of a wide variety of factors (e.g., test conditions, altitude, temperature, background noise, sensor damage, etc.). That is, some pixels that originally recorded “high” values may subsequently record “low” values, and vice versa. Accordingly, the comparison may be limited to a predetermined number (or percentage or other portion) of the pixels. For example, the pixel data at time T2 may be considered matches if at least 20 unique pixels are identified as matches between times T1 and T2.

In another exemplary embodiment the comparison procedure may be streamlined to enhance comparison of the pixel data at times T1 and T2. A truncated list may be generated for each camera sensor including the “top 20” (or however many) unique pixels instead of pixel data for each of the pixels. The list may be generated as pixel data is read out from the camera sensor, as shown in Table 2a for an exemplary camera sensor “A”.

TABLE 2a
Exemplary List for Camera Sensor A

| Pixel Number | Pixel Data |
|---|---|
| 1:2 | 5 |
| 1:9 | 3 |
| 1:36 | 3 |
| 1:45 | 2 |
| 1:58 | 2 |
| . . . | . . . |
| 1:90 | 2 |

As “worse” pixels (e.g., having even higher pixel values) are identified, the pixel location and corresponding pixel data is moved to the top of the list, as illustrated in Table 2b.

TABLE 2b
Exemplary List

| Pixel Number | Pixel Data |
|---|---|
| 2:1 | 9 |
| 1:2 | 5 |
| 5:3 | 5 |
| 3:4 | 4 |
| 1:9 | 3 |
| . . . | . . . |
| 5:3 | 3 |

After all of the pixels have been checked, the list may be used to quickly populate the data structure with unique pixels for the particular camera sensor.

A similar list may also be used when reading pixel data at time T2, so that only the pixels identified as being unique are used in the comparison procedure, and the data structure does not need to be compared to millions of entries each time a camera sensor needs to be identified. Instead, only the list is used for the comparison.

It is noted that the data structure and list does not need to conform to any particular format. The format illustrated above in Tables 1 and Tables 2a and 2b enhance comparison efficiencies by enabling quick identification of the camera sensor in the same data structure without having to obtain patterns of unique pixels and then input those patterns to a separate data structure to identify the camera sensor. However, other formats are also contemplated and would be suitable for use in identifying camera sensors according to the teachings herein.

Before continuing, it is noted that the illustration described above with reference to FIGS. 3a-b is merely exemplary and not intended to be limiting. Other features and/or modifications may also be implemented, as will be readily appreciated by those having ordinary skill in the art after becoming familiar with the teachings herein. By way of example, pixel data from multiple exposures may be averaged and stored in the data structure at time T1 and compared with averaged pixel data obtained from one or more exposures at some later time T2. In addition, the data structure may be updated with pixel data from time T2 and then used at yet another later time (e.g., time T3).

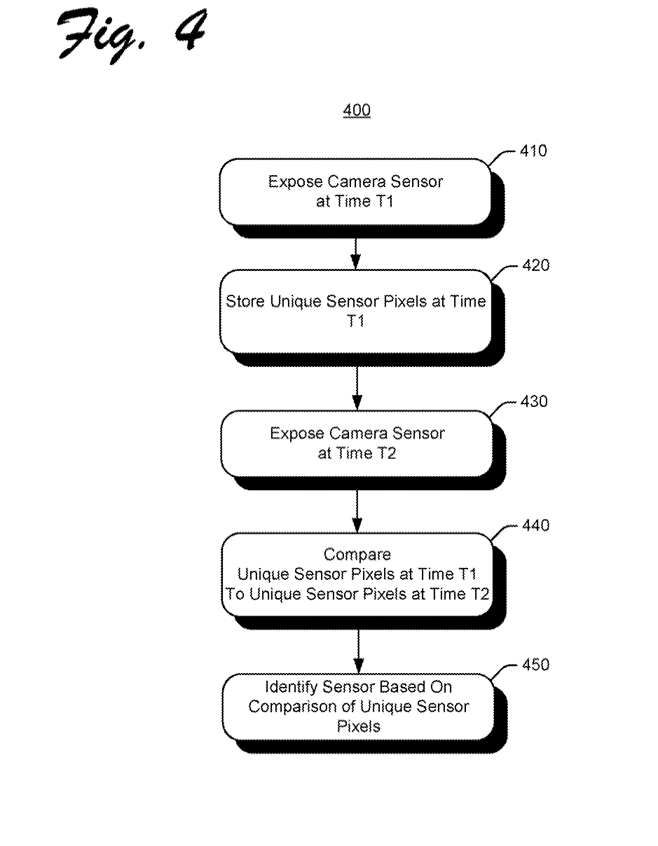

FIG. 4 is a flowchart illustrating exemplary operations which may be implemented for identifying camera sensors. Operations 400 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used.

In operation 410, a camera sensor may be exposed at a time T1 for a predetermined exposure time. For example, the camera sensor may be exposed to a fixed scene (e.g., a dark field or a white field). In operation 420, unique sensor pixels for the exposure at time T1 are stored in memory. For example, an image data signal for the first exposure may be received and processed to determine unique sensor pixels.

In operation 430, the camera sensor may be exposed at a time T2 for a predetermined exposure time. In exemplary embodiments, the camera sensor is exposed to the same, or substantially the same scene (e.g., the dark field or the white field), and the predetermined exposure time is the same or substantially the same as for time T1. Any differences in either the scene or the exposure times may be compensated for so that an accurate comparison of the pixel data can be made.

In operation 440, the unique sensor pixels at time T1 may be compared to the unique sensor pixels at time T2. Exemplary methods of comparing the unique sensor pixels are described above, although other methods are also contemplated. In operation 450, the sensor may be identified based on comparison of the unique sensor pixels.

The operations shown and described herein are provided to illustrate exemplary implementations for identifying camera sensors. The operations are not limited to the ordering shown. In addition, still other operations may also be implemented as will be readily apparent to those having ordinary skill in the art after becoming familiar with the teachings herein. For example, more than two exposures may be used to identify the camera sensor.

It is noted that the exemplary embodiments shown and described are provided for purposes of illustration and are not intended to be limiting. It is also noted that the terms “first” and “second” and times “T1” and “T2” serve merely to distinguish separate instances and are not intended to be limiting in any manner. Still other embodiments are also contemplated for identifying camera sensors.

1. A system for identifying camera sensors, comprising:
a data structure including at least a first field for storing a pixel location, a second field for storing a plurality of camera sensor identifiers corresponding to the pixel location if a camera sensor is determined to have a unique pixel during at least one exposure of a plurality of camera sensors during exposure at a first time T1; and
a comparison engine for comparing unique pixels from exposure of one of the plurality of camera sensors during at least one exposure at a second time T2, the comparison engine identifying the camera sensor from the camera sensor identifier corresponding to the most matching unique pixels during exposure at time T1 and time T2.

2. The system of claim 1, wherein a unique pixel is defined by pixel data obtained at times T1 and T2.

3. The system of claim 1, further comprising a truncated list for comparing unique pixels.

4. The system of claim 3, wherein the truncated list identifies only the top unique pixels.

5. The system of claim 1, wherein the unique pixels are identified from an average of pixel data for a plurality of exposures at time T1.

6. The system of claim 1, wherein the unique pixels are identified from an average of pixel data for a plurality of exposures at time T2.

7. A method for identifying camera sensors comprising:
exposing a plurality of camera sensors at a time T1, each of the plurality of camera sensors having an array of pixels;
storing the location of unique pixels within the array of pixels for each of the camera sensors exposed at time T1 in a data structure;
exposing one of the plurality of camera sensors at time T2;
comparing the unique pixels within the array of pixels for the one camera sensor exposed at time T2 with locations of unique pixels of each of the camera sensors exposed at time T1; and
identifying the one camera sensor based on the comparing step.

8. The method of claim 7, wherein the one camera sensor is exposed to substantially the same scene at time T1 and time T2.

9. The method of claim 7, wherein the one camera sensor is exposed for substantially the same duration at time T1 and time T2.

10. The method of claim 7, wherein the one camera sensor is exposed to a dark field at both time T1 and time T2.

11. The method of claim 7, wherein the one camera sensor is exposed to a white field at both time T1 and time T2.

12. The method of claim 7, further comprising compensating for differences in exposure duration between time T1 and time T2.

13. The method of claim 7, further comprising compensating for differences in the scene between time T1 and time T2.

14. The method of claim 7, further comprising identifying the unique pixels based on pixel data for each pixel location of each of the plurality of camera sensors.

15. The method of claim 7, further comprising updating a streamlined data structure when storing the location of unique sensor pixels.

16. The method of claim 7, further comprising averaging pixel data for a plurality of exposures at time T1 before storing the location of unique sensor pixels.

17. The method of claim 7, further comprising averaging pixel data for a plurality of exposures at time T2 before comparing the unique sensor pixels.

18. The method of claim 7, further comprising recalling at a later time earlier calibration data for the one camera sensor identified.

19. A system for identifying camera sensors, comprising:
means for storing pixel data for a plurality of camera sensors during a manufacturing process;
means for comparing pixel data for at least one of the plurality of camera sensors at a later time to the pixel data stored during the manufacturing process; and
means for identifying the at least one camera sensor based on matching pixel data.

20. The system of claim 19, wherein the pixel data stored and compared includes only unique sensor pixels.

21. The system of claim 19, further comprising means for streamlining the comparison of pixel data.
